(19) United States
(12) Patent Application Publication
(10) Pub. No.: US 2018/0324346 A1
(43) Pub. Date: Nov. 8, 2018

(54) NETWORK CAMERA DEVICE

(71) Applicant: FITIVISION TECHNOLOGY INC., New Taipei City (TW)

(72) Inventor: Ming-Hung Hsieh, New Taipei City (TW)

(21) Appl. No.: 15/586,242

(22) Filed: May 3, 2017

(51) Int. Cl. H04N 5/232; H04N 5/225; H04L 29/06

(52) U.S. Cl. CPC H04N 5/23206; H04L 63/08; H04L 63/10; H04N 5/2251

(57) ABSTRACT

A network camera device includes: a main body, at least one imaging unit configured on at least one side thereof; at least one control device, configured inside the main body; at least one network communication device, configured inside the main body and positioned at one side of the control device, and in information connection therewith, the network communication device providing a user with access to internet; and at least one imaging device, configured inside the main body and installed correspondingly to the imaging unit for shooting, the imaging device positioned at one side of the control device and in information connection therewith, thereby achieving the integration of imaging and internet, and allowing the use to be convenient and the volume to be reduced.

### (a) TECHNICAL FIELD OF THE INVENTION

The present invention relates to a network camera device, and more particularly to a network camera device used for video integration, internet access, use convenience and volume reduction.

### (b) DESCRIPTION OF THE PRIOR ART

In order to be able to view the situation immediately or give the proof of evidence after an event, there are a variety of types of conventional cameras. With the development of sciences and technologies plus the popularity and progress of internet technologies, the signal transmission from conventional cameras to closed storage devices (such as stand-alone version of hard disks) through closed-circuit cable connected is improved to the one from conventional cameras to open storage devices (e.g. computers) through the long-distance connection of internet; open storage devices may be in information connection with conventional cameras, thereby viewing images captured by conventional cameras in a long distance.

But, when a conventional camera having the long-distance connection through internet is required, not only the camera must be installed on a shooting position but at least one network modem is needed to install additionally on a proper position around the camera, with the modem being respectively in connection with the camera and internet such that the installations are rather troublesome, the volume is larger needing much space, and even worse, users are not allowed to access internet.

### SUMMARY OF THE INVENTION

To overcome the defects mentioned above, the present invention is proposed.

The main object of the present invention is to provide a network camera device, allowing internet and imaging effects through integration, thereby reducing volume and being convenient for assembly and use.

To achieve the object mentioned above, the present invention proposes a network camera device, including: a main body, at least one imaging unit configured on at least one side thereof; at least one control device, configured inside the main body; at least one network communication device, configured inside the main body and positioned at one side of the control device, and in information connection therewith, the network communication device providing a user with access to internet; and at least one imaging device, configured inside the main body and installed correspondingly to the imaging unit for shooting, the imaging device positioned at one side of the control device and in information connection therewith.

The present invention integrates the control device, network communication device and imaging device in the main body, allowing the volume to be reduced, assembly time and space to be saved, and operations to be gathered up so that the assembly and use are more convenient. Upon use, the control device will command the network communication device and imaging device to act, allowing a user to use electronic equipment (e.g. cellular phone) to be in information connection with the network communication device (for example, using the wireless network technology) to have access to internet. Furthermore, the imaging device will shoot continuously, and the control device may allow a user to obtain images captured by the imaging device selectively from the network communication device. Through the above technologies, the troublesome assembly, larger volume and incapability of access to internet of conventional cameras can be broken through, achieving the integration of imaging and internet, and allowing the use to be convenient and the volume to be reduced.

### BRIEF DESCRIPTION OF THE DRAWINGS

FIGS. 1 and 2 respectively are a schematically perspective view of a preferred embodiment according to the present invention;

FIG. 3 is a structural block diagram of the embodiment according to the present invention;

FIG. 4 is a schematically perspective view of the embodiment according to the present invention upon image pickup;

FIG. 5 is a schematically perspective view of the embodiment according to the present invention showing that a user has access to internet through a network camera device of the present invention;

FIG. 6 is a schematically perspective view of the embodiment according to the present invention upon monitoring;

FIG. 7 is a schematically perspective view of another preferred embodiment according to the present invention; and FIG. 8 is a schematically perspective view of yet another preferred embodiment according to the present invention.

### DETAILED DESCRIPTION OF THE PREFERRED EMBODIMENTS

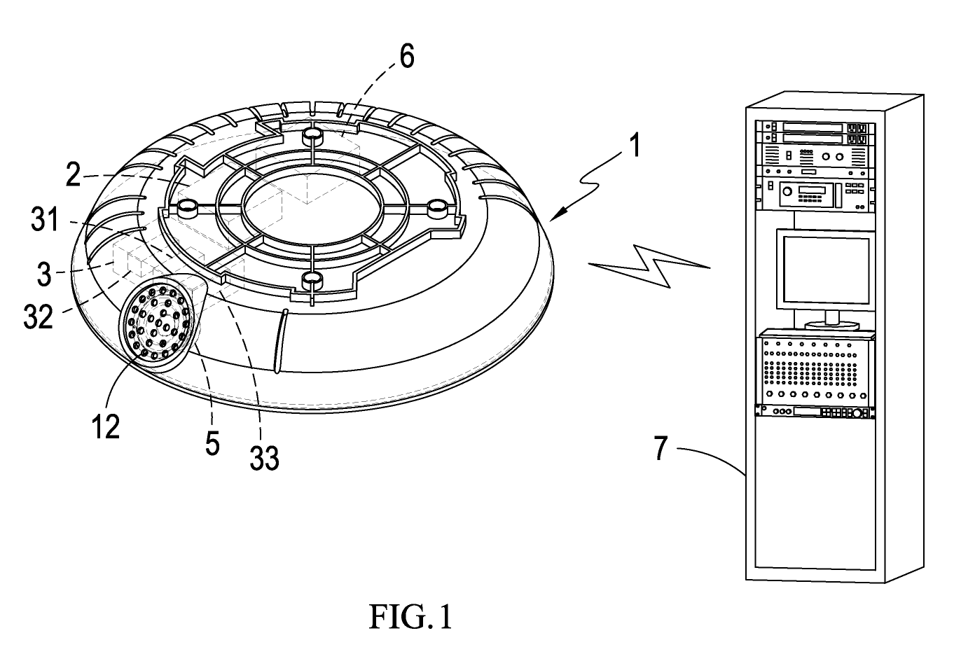

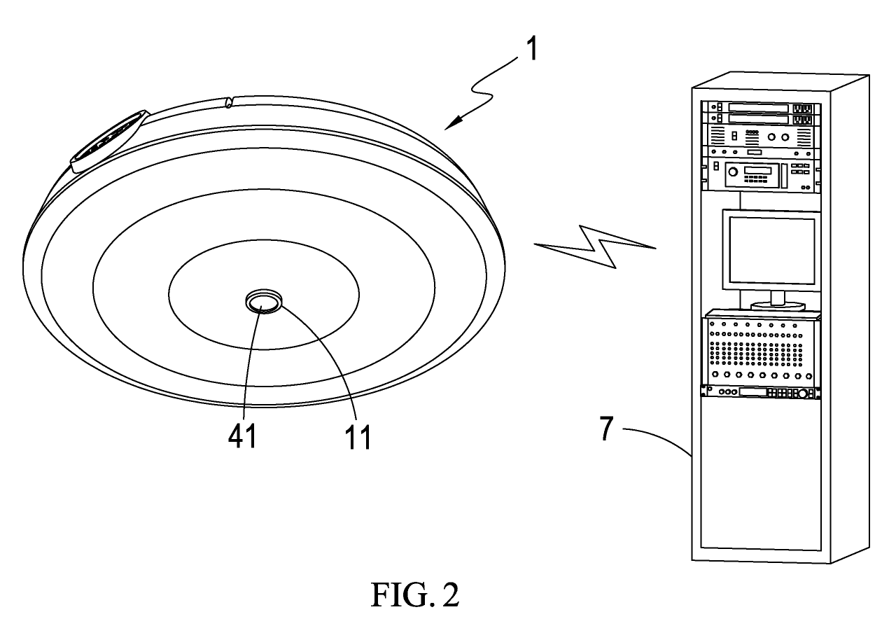

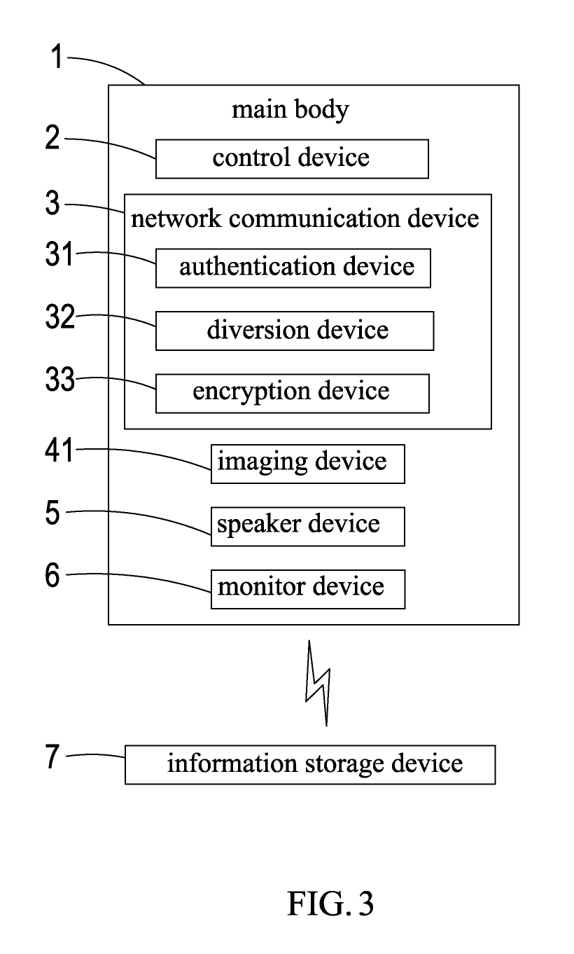

Referring to FIGS. 1 to 3, which respectively are a schematic view, schematic view and structural block diagram of a preferred embodiment of the present invention, a network camera device of the present invention includes: a main body 1; at least one imaging unit 11, configured on at least one side of the main body 1; and at least one speaker unit 12, where at least one control device 2, at least one network communication device 3, at least one imaging device 41, at least one monitor device 6 and at least one speaker device 5 are configured inside the main body 1.

Furthermore, the network communication device 3 is positioned at one side of the control device 2 and in information connection therewith, capable of providing a user with access to internet. The network communication device 3 includes at least one authentication device 31, at least one diversion device 32 configured at one side of the authentication device 31 and in information connection therewith and at least one encryption device 33 configured at one side of the authentication device 31 and in information connection therewith.

Imaging device 41 is positioned at one side of the control device 2 and in information connection therewith, and configured correspondingly to the imaging unit 11 for shooting.

The monitor device 6 is configured at one side of the control device 2 and in information connection therewith for information transmission, where the monitor device 6 may use a Bluetooth technology, infrared transmission technology or wireless fidelity technology.

The speaker device 5 is configured at one side of the control device 2, and in information connection therewith, where the speaker device 5 is positioned correspondingly to the speaker unit 12 so as to facilitate sound emission.

In addition, the network communication device 3 is in information connection with at least one information storage device 7. In the embodiment, the network information storage device 7 is a computer servo host, but the present invention is not so limited.

Referring to FIGS. 1 to 6, it can be seen clearly from the figures that the control device 2, network communication device 3, imaging device 41, speaker device 5 and monitor device 6 are accommodated and integrated in the main body 1 according to the present invention so that it is possible to omit the trouble for wire connection among the above devices, and the volume of the network camera device of the present invention can thus be reduced substantially so as to save space, allowing the installation thereof is more convenient and fast.

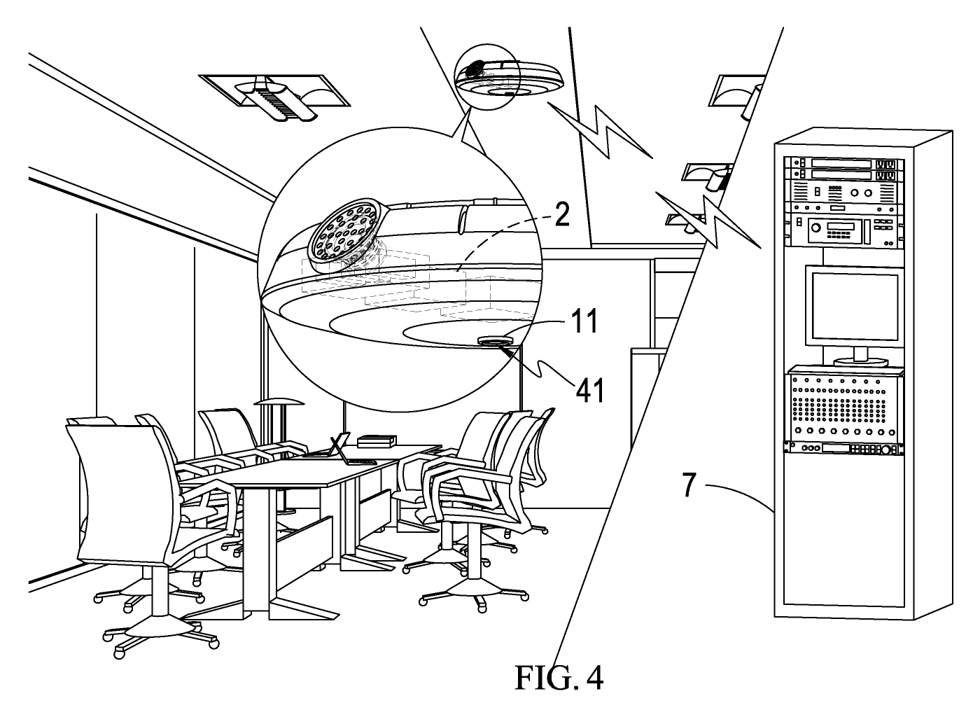

Referring to FIG. 4 again, the control device 2, upon use, commands the imaging device 41 to act to perform shooting from the imaging unit 11, and the images captured thereby may be transmitted to and stored in an information storage device 7.

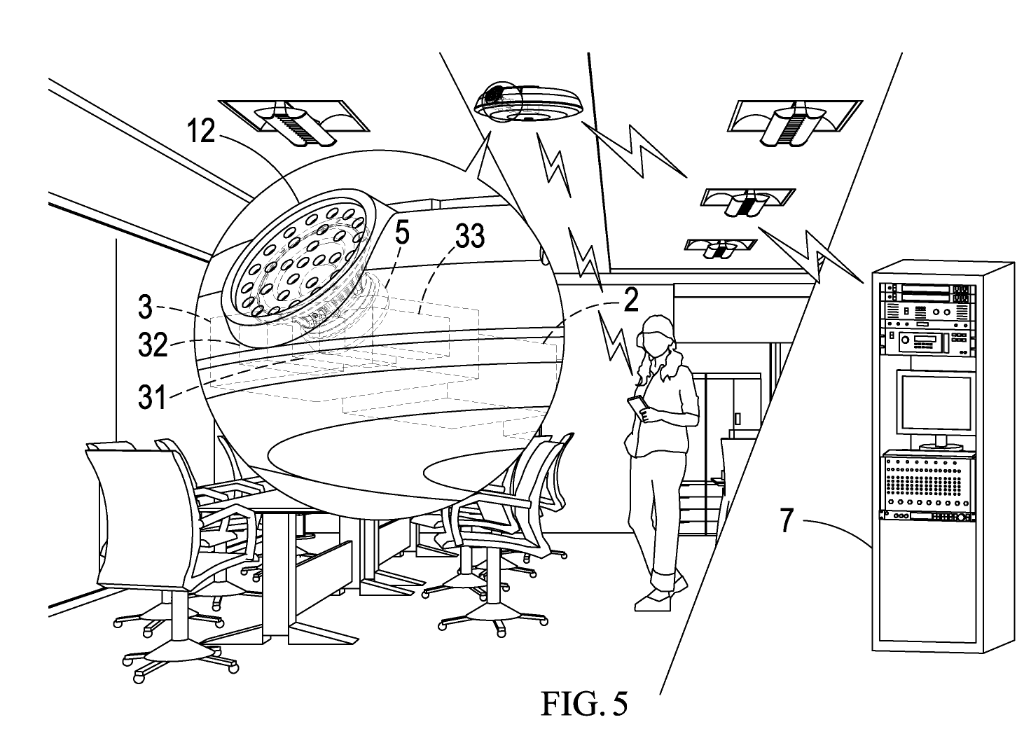

Referring to FIG. 5 again, the control device 2 also commands the network communication device 3 to act so as to allow a user to operate electronic equipment (e.g. cellular phone) to be in information connection with the network communication device 3 (for example, using the wireless network technology) to have access to internet, and the encryption device 33 continues to keep information confidential.

In addition, the authentication device 31 will perform authentication (e.g. account number, pass word and etc) when the network communication device 3 is connected to determine a user's rights and in information connection with the control device 2 depending on the authentication result so as to provide the user selectively with different functions. For example, if the user is a general visitor after the authentication, only general internet service is provided; if a member of internal staff, besides general internet service, the service of the connection with the information storage device 7 may further be provided, allowing the internal data to be shared, or the service of driving the speaker device 5 may be provided, allowing the speaker device 5 to be acted according to the operation of a user to generate sound passing through the speaker unit 12 to broadcast.

Otherwise, when a user is authenticated as a general visitor, the diversion device 32 is acted to allot a lower-bandwidth network channel (e.g. 2.4 G) to the user; when a member of internal staff, a wider-bandwidth network channel (e.g. 5 G) is allotted.

Furthermore, the diversion device 32 is acted automatically to switch users' network channels (e.g. 5 G network channels) to other channels (e.g. 2.4 G network channels) when a certain network channel (e.g. 5 G network channel) is used too often causing network traffic jam so as to achieve automatic diversion.

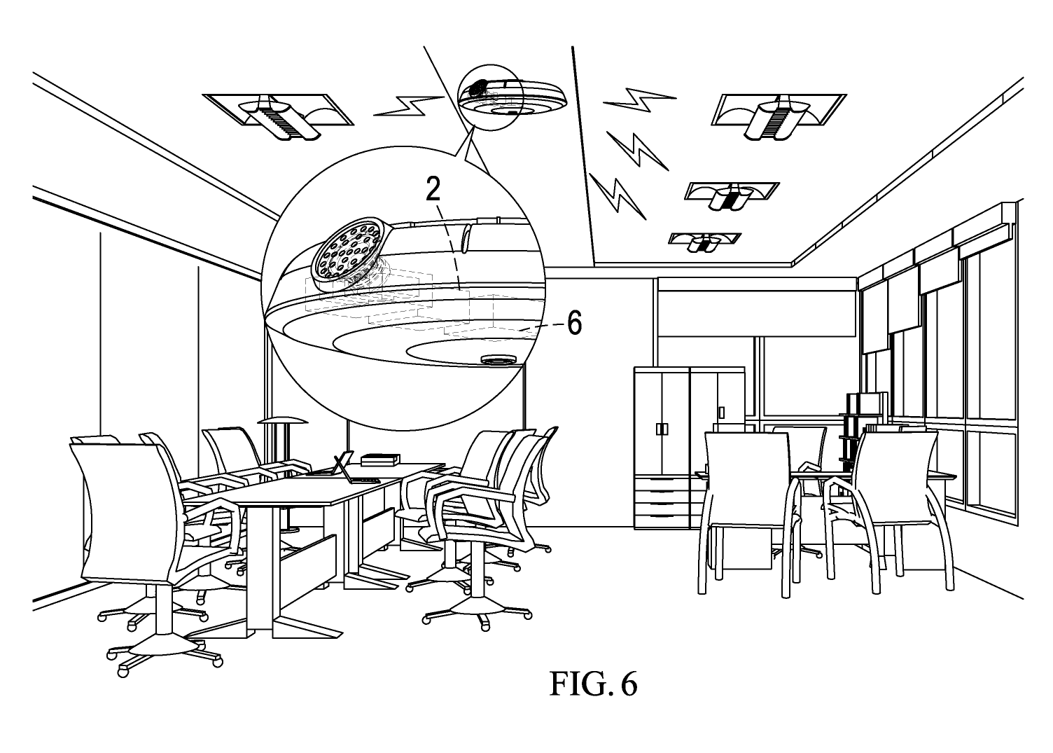

Referring to FIG. 6 again, the control device 2 may command the monitor device 6 to be in information connection with a plurality of electronic equipment so as to monitor or control each piece of electronic equipment (e.g. lamps and etc), further achieving the concept of internet of things.

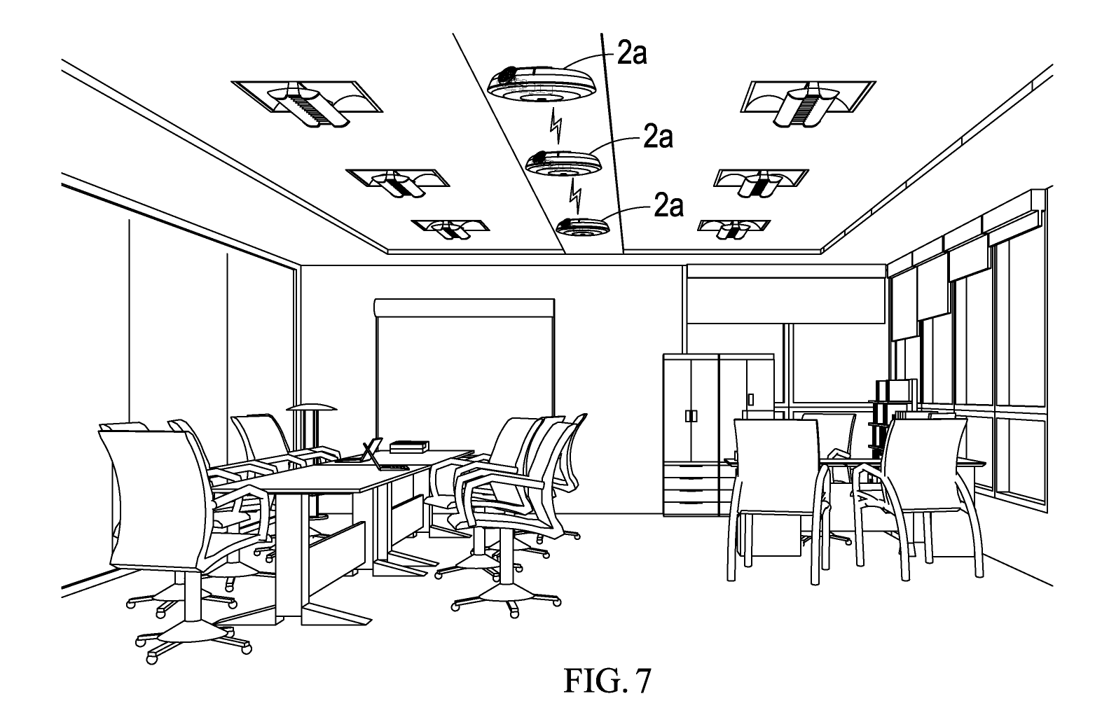

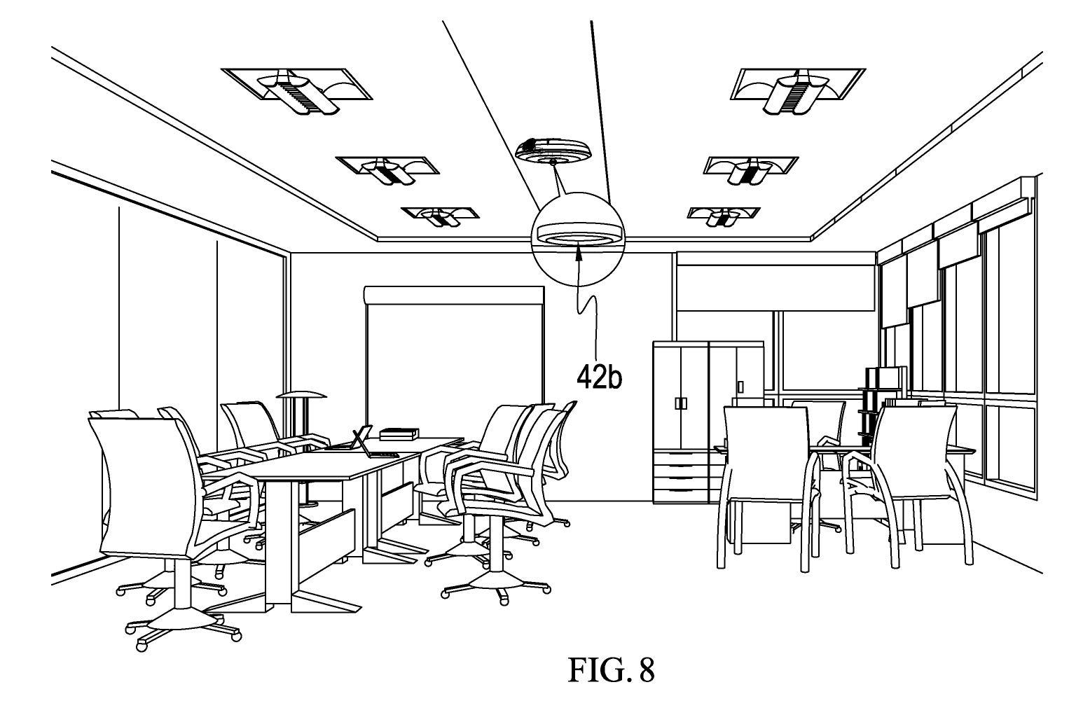

Referring to FIG. 7, in another preferred embodiment, the plurality of network camera devices of the present invention are in information connection with one another, where the target control device 2a may be operated, setting the target control device 2a as an area host to uniformly control the control devices 2a in information connection therewith around it.

Referring to FIG. 8, showing yet another preferred embodiment, the present embodiment is almost similar to the embodiments mentioned above except the imaging device of the above embodiments is replaced with a fish-eye imaging device 42b in the present embodiment, thereby carrying out 360 degree shooting to increase a shooting range.

Therefore, the key point where the network camera device of the present invention can improve the prior art is in that the main body 1 is used to include the control device 2, network communication device 3 and imaging device 41 together, allowing the present invention to achieve the integration of the imaging with internet, and to be used conveniently and reduced in volume.

I claim:

1. A network camera device, comprising:
a main body, at least one imaging unit configured on at least one side thereof;
at least one control device, configured inside said main body;
at least one network communication device, configured inside said main body and positioned at one side of said control device, and in information connection therewith, said network communication device providing a user with access to internet; and
at least one imaging device, configured inside said main body and installed correspondingly to said imaging unit for shooting, said imaging device positioned at one side of said control device and in information connection therewith.

2. The network camera device according to claim 1, wherein said network communication device comprises at least one authentication device, at least one diversion device configured at one side of said authentication device and in information connection therewith, and at least one encryption device configured at one side of said authentication device and in information connection therewith.

3. The network camera device according to claim 1, wherein said network communication device is in information connection with at least one information storage device.

4. The network camera device according to claim 1, wherein at least one monitor device is in information connection with said control device and configured at one side thereof.

5. The network camera device according to claim 1, wherein at least one speaker unit is configured on said main body, and at least one speaker device one side of said speaker unit inside said main body, with said speaker device being configured at one side of said control device and in information connection therewith.

6. A network camera device, comprising:
a main body, at least one imaging unit configured on at least one side thereof;
at least one control device, configured inside said main body;
at least one network communication device, configured inside said main body and positioned at one side of said control device, and in information connection therewith, said network communication device providing a user with access to internet; and
at least one fish-eye imaging device, configured inside said main body and installed correspondingly to said imaging unit for 360 degree shooting, said fish-eye imaging device positioned at one side of said control device and in information connection therewith.

7. The network camera device according to claim 6, wherein said network communication device comprises at least one authentication device, at least one diversion device configured at one side of said authentication device and in information connection therewith, and at least one encryption device configured at one side of said authentication device and in information connection therewith.

8. The network camera device according to claim 6, wherein said network communication device is in information connection with at least one information storage device.

9. The network camera device according to claim 6, wherein at least one monitor device is in information connection with said control device and configured at one side thereof.

10. The network camera device according to claim 6, wherein at least one speaker unit is configured on said main body, and at least one speaker device one side of said speaker unit inside said main body, with said speaker device being configured at one side of said control device and in information connection therewith.
